(19) United States
(12) Patent Application Publication
(10) Pub. No.: US 2017/0337407 A1
(43) Pub. Date: Nov. 23, 2017

(54) METHOD FOR DISPLAYING BARCODE ON ACTIVE BARCODE DISPLAY AND ELECTRONIC DEVICE OF THE SAME

(71) Applicants: Yu-Chih JEN, Taipei City (TW); AROLLTECH CO., LTD., Grand Cayman (KY)

(72) Inventors: Yih CHANG, New Taipei City (TW); Yu-Chih JEN, Taipei City (TW)

(21) Appl. No.: 15/156,976

(22) Filed: May 17, 2016

(51) Int. Cl. G06K 7/14; G06K 19/06; G06T 11/20

(52) U.S. Cl. CPC G06K 7/1404; G06T 11/203; G06K 19/06018; G06K 19/06037; G06K 19/06112

(57) ABSTRACT

The disclosure provides a method for displaying a barcode. The method includes: utilizing an electronic device to obtain information; and displaying a barcode on an active barcode display according to the information; wherein when displaying the barcode on the active barcode display of the electronic device, a contrast ratio of black and white bar codes in the barcode is greater than about 30%. Another method for displaying a barcode is also provided, the method includes: utilizing an electronic device to identify a barcode displayed on a display of the electronic device to generate information; and displaying a generated barcode on an active barcode display according to the information; wherein when displaying the generated barcode on the active barcode display of the electronic device, a contrast ratio of black and white bar codes in the generated barcode is greater than 30%. Associated electronic devices are also disclosed.

### TECHNICAL FIELD

The present disclosure relates to a method for displaying a barcode and an electronic device of the same.

### DISCUSSION OF THE BACKGROUND

With the vigorous development within the field of mobile commerce in which a user can conduct several types of commercial transactions with a single electronic device, the services and/or functions of mobile commerce using electronic devices are widely expanding. The use of either one-dimensional barcode or two-dimensional barcode or both to achieve all types of commercial transactions is convenient in many aspects of everyday life. While typically printed on paper labels and stubs, barcodes have also been presented statically on the electronic displays of mobile communications devices. However, reading static barcodes from displays has been problematic. A barcode reader is generally unable to accurately recognize a barcode displayed in the electronic displays. Specifically, when the barcode reader reads information on the barcode displayed in the electronic displays, a recognition rate of recognizing the information on the barcode is deteriorated noticeably because a laser generated in the barcode reader is diffusely reflected from a liquid crystal display (LCD) screen of the electronic device, plus other factors such as backlit display, and/or polarizing filter, causing a contrast ratio being degraded and a minimum requirement to correctly identify the barcode being hindered. In addition,the Moire fringe effect may also cause malfunction of the barcode reader.

As such, how to overcome the above mentioned issues has become an urgent issue in the field of mobile commerce.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY

One of the objectives of the present invention is to disclose methods and associated electronic devices for displaying barcodes, so as to resolve the issue.

According to a first aspect of the present invention, a method for displaying a barcode is disclosed. The method includes: utilizing an electronic device to obtain information; and displaying a barcode on an active barcode display of the electronic device according to the information; wherein when displaying the barcode on the active barcode display, a contrast ratio of black and white bar codes in the barcode is greater than about 30%.

According to a second aspect of the present invention, an electronic device is disclosed. The electronic device includes a receiving unit and an active barcode display. The receiving unit is arranged for obtaining information. The active barcode display is arranged for displaying a barcode according to the information. When displaying the barcode, a contrast ratio of black and white bar codes in the barcode on the active barcode display is greater than about 30%.

According to a third aspect of the present invention, a method for displaying a barcode includes: utilizing an electronic device to identify a first barcode displayed on a display of the electronic device to generate information; and displaying a second barcode on an active barcode display of the electronic device according to the generated information; wherein when displaying the second barcode on the active barcode display of the electronic device, a contrast ratio of black and white bar codes in the second barcode is greater than about 30%.

According to a fourth aspect of the present invention, an electronic device is disclosed. The electronic device includes a receiving unit and an active barcode display. The receiving unit is arranged for identifying a first barcode displayed on a display of the electronic device to generate information. The active barcode display is arranged for displaying a second barcode according to the information. When displaying the second barcode, a contrast ratio of black and white bar codes in the second barcode on the active barcode display is greater than about 30%.

The foregoing outlines features of several embodiments so that those skilled in the art may better understand the aspects of the present disclosure. Other technical features and advantages constituting claims of the present disclosure are described in the following descriptions. Those skilled in the art should appreciate that they may readily use the present disclosure as a basis for designing or modifying other processes and structures for carrying out the same purposes of the embodiments introduced herein. Those skilled in the art should also realize that such equivalent constructions do not depart from the spirit and scope of the present disclosure, and that they may make various changes, substitutions.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a flowchart illustrating a method for displaying a barcode according to an embodiment of the present disclosure;

FIG. 2 is a diagram illustrating an electronic device employing the method of FIG. 1;

FIG. 3 is a diagram illustrating an ear speaker of the electronic device of FIG. 2 displaying a one-dimensional barcode;

FIG. 4 is a diagram illustrating an ear speaker of the electronic device of FIG. 2 displaying a two-dimensional barcode;

FIG. 5 is a diagram illustrating another electronic device employing the method of FIG. 1;

FIG. 6 is a diagram illustrating a proximity sensor of the electronic device of FIG. 5;

FIG. 7 is a diagram illustrating still another electronic device employing the method of FIG, 1;

FIG. 8 is a flowchart illustrating a method for displaying a barcode according to another embodiment of the present disclosure;

FIG. 9 is a flowchart illustrating a method for displaying a barcode according to still another embodiment of the present disclosure; and

FIG. 10 is a diagram illustrating an electronic device employing the method of FIG. 9.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

The electronic device mentioned in the present disclosure can, for example, be a handheld computer, a personal digital assistant, a cellular telephone, a camera, a feature phone, a smart phone, a wearable watch, a wearable glasses, a handheld game console, a handheld music player or other electronic device, or a combination of any two or more of these data processing devices or other data processing devices. The electronic device can be used to recognize individual identification, or conduct mobile commerce functions, such as on-line payments and credit authorization identification, at any location and time through barcodes handshaking with another electronic devices and/or barcode readers. For example, through the electronic device, a user can access a server of an on-line market or a digital coupons and offers platform to receive data such as coupons of a specific product and the like from the on-line server or platform. In another example, a user can access a server of a payment platform acting as an intermediary agent between the merchant and the user to handle the payment through the electronic device. While the payment platform receives payment, acknowledgement of the payment, or the authorization of payment from the user, the merchant receives payment from the payment platform. However, the present disclosure is not limited thereto. One of ordinary skill in the art would recognize many variations, modifications, and alternatives.

The barcodes mentioned above are machine-readable data codes that serve a broad range of organizational and financial applications. Barcodes are used to keep track of shipments, price retail items, manage financial documents, and to perform many other logistical and organizational services because a large amount of coded information can be translated into barcode symbology, and then scanned and read by different types of barcode readers and electronic devices.

Specifically, barcodes, such as one-dimensional barcodes (e.g. Universal Product Code (UPC)), use thin and thick bar patterns to represent data while more complex coding systems, known as matrix barcodes (or two-dimensional barcodes or quick response (QR) codes), use intricate patterns of blocks and arrangements to store masses of information. Both types of barcode are able to store information for later use if read by a barcode reader, which convert the optical reflectivity or optical information into a digital signal. The digital signal is transformed into the numbers and/or characters and then sent on to perform another function, such as representing information on a digital read out or logging stock in an inventory database. However, the present disclosure is not limited thereto. One of ordinary skill in the art would recognize many variations, modifications, and alternatives.

Barcode readers mentioned in the present disclosure may be differentiated by technologies, including pen-type readers, laser scanners, CCD readers, camera-based readers, video camera readers, large field-of-view readers, omni-directional barcode scanners; or may be distinguished based on housing design, including handheld scanners, pen scanners (or wand scanners), stationary scanners, fixed-position scanners, PDA scanners (or Auto-ID PDAs), automatic readers, and cordless scanners (or Wireless scanners). However, the present disclosure is not limited thereto. One of ordinary skill in the art would recognize many variations, modifications, and alternatives.

Normally, a screen (e.g., a liquid crystal display (LCD)) embedded in an electronic device can display information for a user to read. But when a user tries to use a barcode reader to scan and read a barcode displayed on the screen, the barcode reader usually fails to recognize the barcode. The reasoning for such a phenomenon relates to the fact that an architecture and design of the screen is not suitable to display a barcode for a barcode reader to read. Specifically, when a barcode reader reads a barcode displayed on an electronic device, a laser or LED light emitted from the barcode reader is diffusely reflected from a screen of the electronic device and thus, remarkably deteriorates the recognition of the information on the barcode. In addition to the strong light scattering issue, the Moire fringe effect also interfere with reader recognition.

The concept of the present disclosure is to provide a method to solve the problem faced when using a barcode reader to read a barcode on a screen of an electronic device by using another dedicated and separated display which is designed for displaying a barcode reliably readable by a barcode reader instead of showing information for a user to read. The active barcode display needs to resolve all the issues that existing LCD and AMOLED displays have, and to allow all of the barcode readers and other electronic devices such as digital camera to reliably and easily recognize and decode both one-dimensional and two-dimensional barcodes. Details of the method are described as follows.

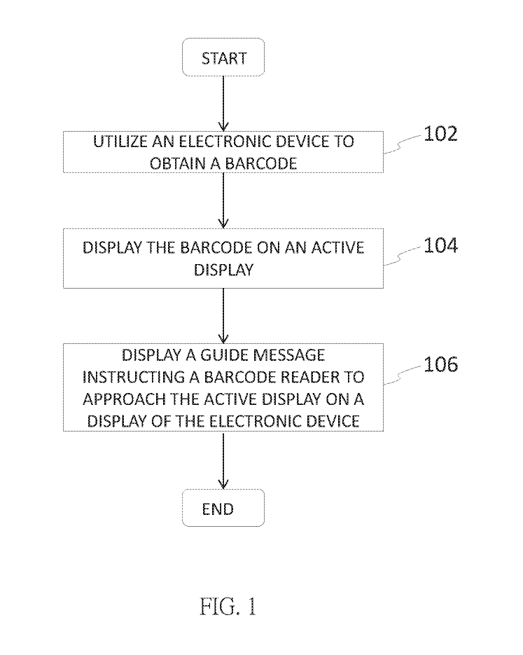

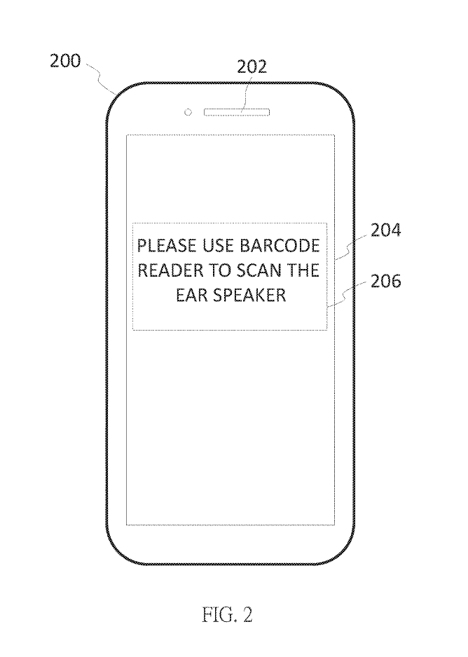

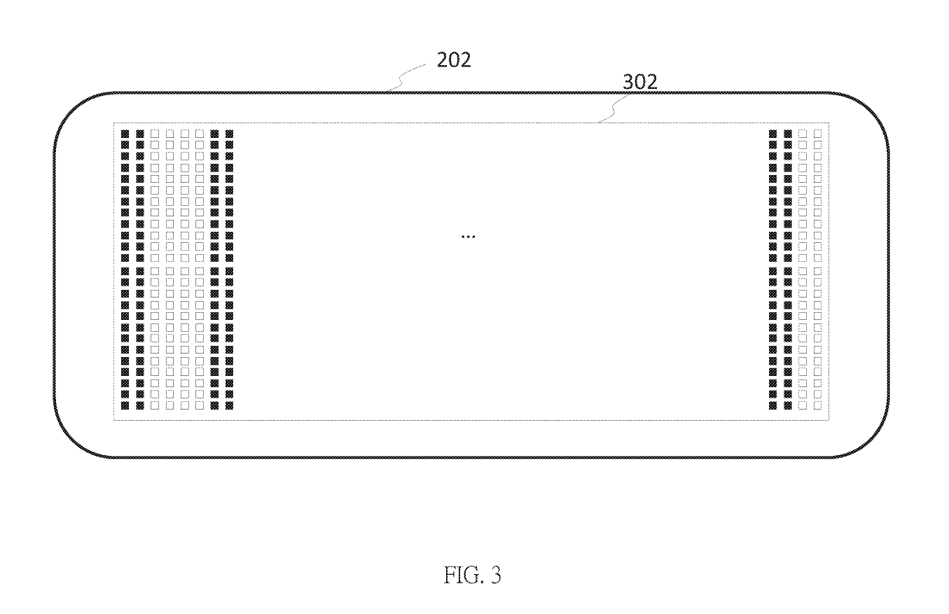

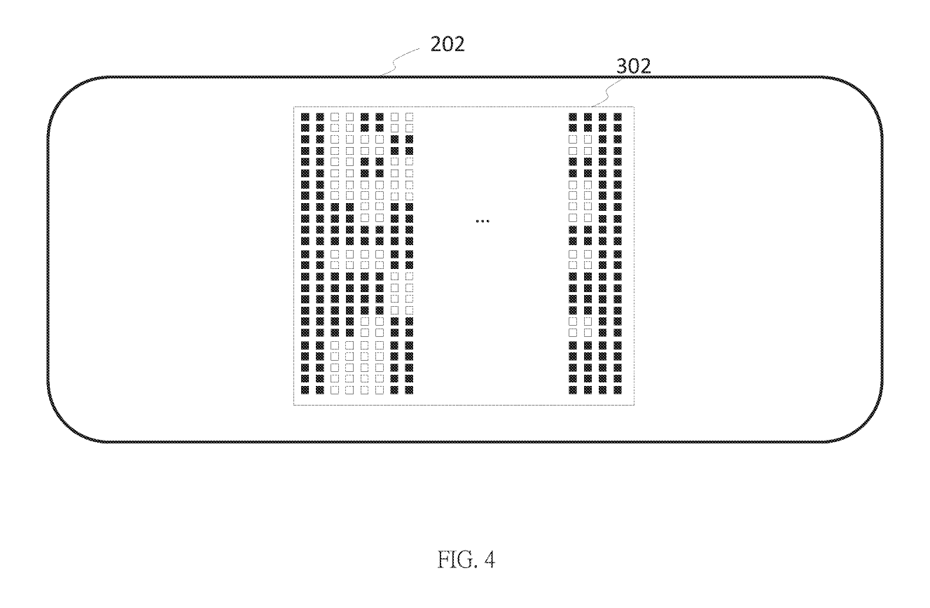

FIG. 1 is a flowchart illustrating a method for displaying a barcode in an active barcode display according to an embodiment of the present disclosure. Please refer to FIG. I in conjunction with FIGS. 2-4. An electronic device 200 includes an ear speaker 202 and a display 204. An active barcode display 302 is disposed in the ear speaker 202. The active barcode display 302 mentioned here refers to electronic visual displays present visual information according to the electrical input signal (analog or digital) by emitting light. The active barcode display 302 includes a plurality of pixels which can be separately turned on and off. The dimension of the active barcode display 302 may be chosen based on the barcode standards, and is not a limitation of the present disclosure. For instance, when a pixel is used to indicate a one-dimensional barcode, the dimension of the active barcode display 302 may be 25 pixel*100 pixel as illustrated in FIG. 3; when a pixel is used to indicate a two-dimensional barcode, the dimension of the active barcode display 302 may be 25 pixel*25 pixel as illustrated in FIG. 4. When a pixel is used to indicate a black bar of a one-dimensional barcode, the pixel is turned off as solid blocks illustrated in the active barcode display 302 as illustrated in FIG. 3; on the contrary, the pixel is turned on when indicating a white bar, as hollow blocks illustrated in the active barcode display 302 of FIG. 3. When a pixel is used to indicate a black element of a two-dimensional barcode, the pixel is turned off as solid blocks illustrated in the active barcode display 302 as illustrated in FIG. 4; on the contrary, the pixel is turned on when indicating a white element, as hollow blocks illustrated in the active barcode display 302 of FIG. 4. Please note that unlike the display 204 using sub-pixels R, G and B to jointly form a pixel, the active barcode display 302 is composed of a plurality of identical uniform pixels. However, this invention is not just limited to the pixel only and the concept can also apply to the active barcode display with various sub-pixel structures.

In this embodiment, the active barcode display 302 is an electroluminescent display. Specifically, the active barcode display 302 is an organic light-emitting diode (OLED) display. But this is not a limitation of the present disclosure. In some embodiments, the active barcode display 302 may be a light emitting diode (LED) display, an inorganic electroluminescent (EL) display, a gas discharge display, a liquid crystal display (LCD) with backlighting, a cathodoluminescent display, a photoluminescent display, an incandescent display, or a quantum dot light-emitting diode (QLED) array display. The cathodoluminescent display may include a cathode ray tube (CRT) display, a field emission display (FED), a vacuum fluorescent display (VFD) and a surface-conduction electron-emitter display (SED). The photoluminescent display may include a plasma display panel (PDP), an electronic control ink display or an e-ink display.

The dimension of pixel pitch and gap between pixels of the active barcode display 302 depends on the situations. For instance, the gap may be determined according to a gap between pixels of a CMOS barcode reader used to read the active barcode display at specific distance range. In this embodiment, the pixel pitch is less than 10 micro meters and the gap between pixels is less than 2 micro meters. The total pitch and entire active barcode display dimensions depends on how many characters to cover both one-dimensional barcode and two-dimensional barcode information and the location of the active barcode display 302 in this electronic device 200. More specifically, when displaying the barcode on the active barcode display, a minimum requirement of a contrast ratio of black and white bar codes in the barcode for a barcode reader to read is better to be more than about 30% in order to allow barcode reader and other electronic device to quickly and reliably decode the barcode information according to ISO/IEC or CEN/ANSI compliant verification. To this end, a black cathode layer and a black matrix may be adopted to absorb and reduce the light reflection and inter-pixel interference. For instance, the light reflectivity may be 6%-70% according to the black cathode architectures. In addition, anti-reflection (AR) and anti-glare (AG) glass surface treatment may also be employed in order to reduce light scattering. In some embodiments, when the active barcode display 302 is an LED display, the LED display may adopt a black resin or other materials to effectively absorb the strong incoming light from barcode reader. These self-emitting active barcode displays can be designed to simulate the barcode printed on the papers, woods, and metal cans, in which the dark ink absorbs the incoming red or infrared light from the barcode reader whereas the white ink reflect the light to allow the reader see the reflectivity contrast and then convert into electric signal and translate to decode the barcode information. The advantages of these active barcode displays can directly emit omni-directional light signal with very sharp and good intensity contrast which is much better than the printed barcode in the papers. The surface of these barcode displays can also deposit special optical coating or treatment (e.g. AR and AG) to reduce the light scattering because this surface doesn't need the touch functions. In the meantime, the pixel design of these active barcode displays can specially design to minimize Moire fringe effect. Therefore, this active barcode display can offer an electronic platform to readily show one-dimensional barcode and two-dimensional barcodes to allow user clearly see the barcode for his payment and also allow barcode reader to read the barcode in a very quick and reliable way. However, the present disclosure is not limited thereto. One of ordinary skill in the art would recognize many variations, modifications, and alternatives.

In step 102, a receiving unit of the electronic device 200 is utilized to obtain a barcode, including encoded/unencoded barcode, from a remote server, such as a remote transaction server of a third party payment system or a ticket/coupon system, via wireless transmission, according to predefined design specifications. In some embodiments, the barcode may have a validity period after the barcode being obtained and downloaded to the electronic device. In some embodiments, the barcode may be stored in a memory module of the electronic device without a validity period after the barcode being obtained and downloaded to the electronic device. The wireless transmission includes Bluetooth and Wireless Local Area Network (WLAN) as well as ITU/3GPP mobile communications protocol or other wireless protocol with suitable transmission speed. However, the present disclosure is not limited thereto. One of ordinary skill in the art would recognize many variations, modifications, and alternatives. In step 104, the electronic device 200 displays the barcode on the active barcode display 302 to allow the barcode reader to read. In some embodiments, when the barcode is stored in a memory module of the electronic device, a user can arbitrarily select the desired barcode from the display 204 and show the barcode on the active barcode display 302. Optionally, a guide message 206 “PLEASE USE BARCODE READER TO SCAN THE EAR SPEAKER” may be displayed on the display 204 of the electronic device 200 in order to instruct a barcode reader to approach the active barcode display 302 located in the ear speaker 202 in step 106.

In some embodiments, the barcode and/or associated barcode information number may be also displayed on the display 204 at least in the course of the operation of steps 102-104. The barcode information number may include a country code, a manufacture number, a product number or a check digit. The barcode information number may be manually entered when a barcode reader fails to read the barcode on the active barcode display 302.

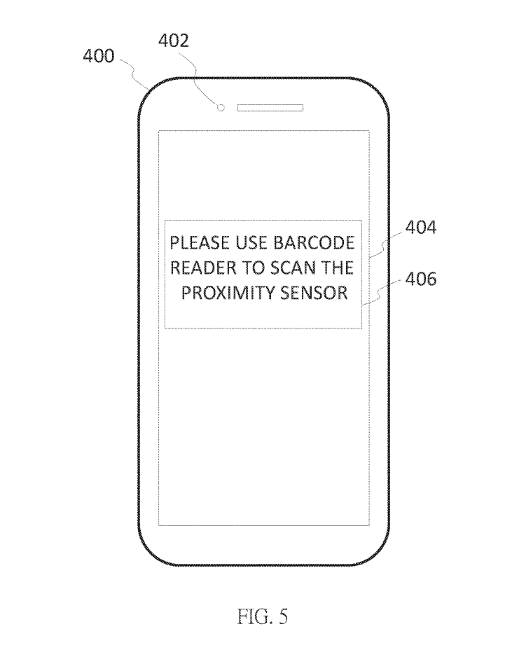

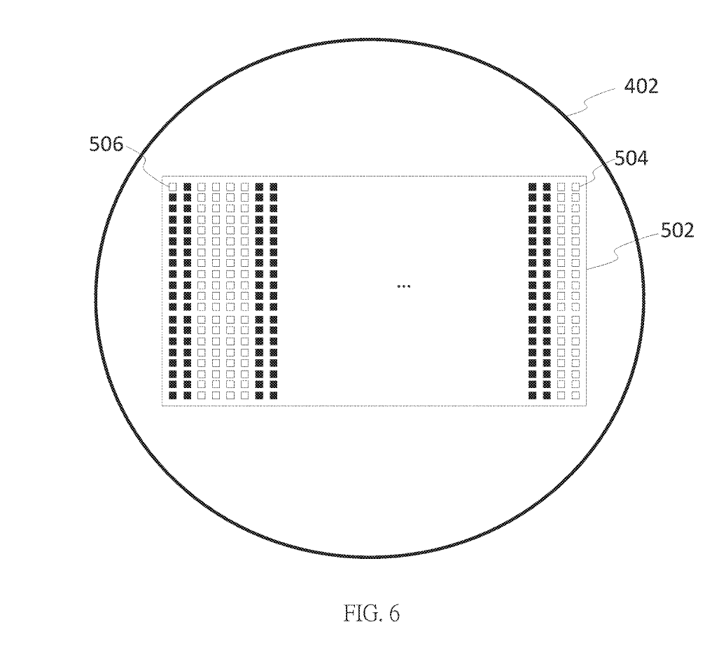

FIG. 5 is a diagram illustrating another electronic device employing the method of FIG. 1. Please refer to FIG. 5 in conjunction with FIG. 6, wherein an electronic device 400 includes a proximity sensor 402 and a display 404. An active barcode display 502 is disposed in or integrated with the proximity sensor 402, and the implementation of the active barcode display 502 is similar to the active barcode display 302. As a result, details of the active barcode display 502 are omitted here for brevity. Optionally, in order to integrate the active barcode display 502 with a proximity sensor originally disposed in the proximity sensor 402, one or more red pixels of the active barcode display 502 may replace the proximity sensor transmitter 504; and one pixel position of the active barcode display 502 nearby 502 may replace the proximity sensor receiver 506. However, the present disclosure is not limited thereto. One of ordinary skill in the art would recognize many variations, modifications, and alternatives. That means the active barcode display can be disposed at any location of the electronic devices, i.e. six sides of the electronic devices. In some embodiments, the location of the active barcode display may be determined depending on a dimension specification in order to clearly show both one-dimensional and two-dimensional barcodes. In some embodiments, the location of the active barcode display may be determined to achieve a better appearance for entire electronic device.

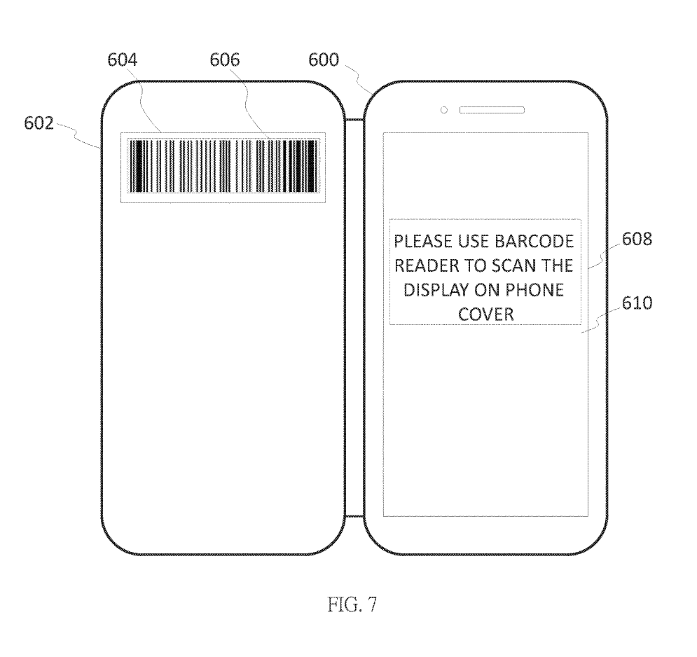

FIG. 7 is a diagram illustrating still another electronic device employing the method of FIG. 1. Referring to FIG. 7, an electronic device 600 includes a display 608. An external accessory 602, i.e. a cover, of the electronic device 600, is also depicted in FIG. 7. The display 608 is a main display for providing information to a user, where the information includes contents such as texts and/or pictures. The external accessory 602 includes an active barcode display 604 which is capable of showing a barcode 606 for a barcode reader to read. Implementation of the active barcode display 604 is similar to the active barcode displays 302 and 502. As a result, details of the active barcode display 604 are omitted here for brevity. The electronic device 600 may encode and transmit the barcode desired to display to the accessory 602 via connector (not shown here) or wireless transmission. The wireless transmission includes Bluetooth or Wireless Local Area Network (WLAN) as well as ITU/3GPP mobile communications protocol or other wireless protocol with suitable transmission speed. Thereafter, the active barcode display 604 of the accessory 602 can display the barcode 606 to allow the barcode reader to read. However, the present disclosure is not limited thereto. The external accessory 602 and the way to transmit the barcode may be in other forms. One of ordinary skill in the art would recognize many variations, modifications, and alternatives.

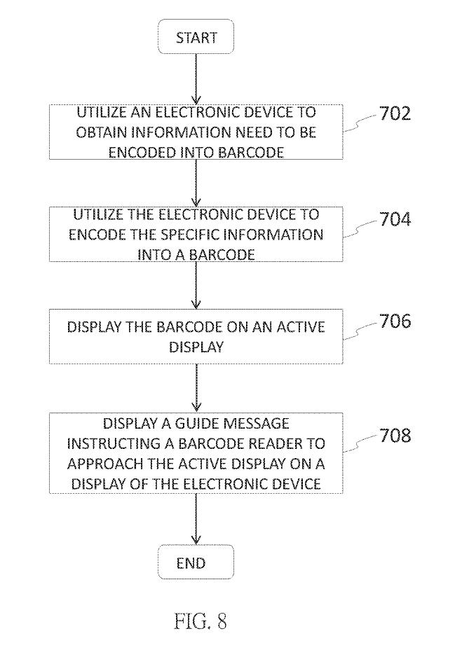

FIG. 8 is a flowchart illustrating a method for displaying a barcode according to another embodiment of the present disclosure. The difference between the embodiment of FIG. 8 and the embodiment of FIG. 1 is that in the embodiment of FIG. 8, an electronic device obtains information which needs to be encoded into barcode instead of directly receiving a barcode in step 702. The information, for example, may include shipments, price retail items, financial documents, and other logistical and organizational services. Thereafter, the electronic device encodes the information into a barcode according to step 704. Types of the encoded barcode are not limited to a specific standard, for example, the barcode may be encoded according to UPC-A, EAN-13, Code 93, or Code 128, or QR code standard by a software program executed on the electronic device. In some embodiments, the barcode may have a validity period after the information being received and downloaded to the electronic device. In some embodiments, the barcode may be stored in a memory module of the electronic device without a validity period after the information being received and downloaded to the electronic device. The subsequent steps 706-708 are the same or similar to the steps 104-106 of FIG. 1; thus, details are omitted here for brevity. The method shown in FIG. 8 can be applied to the electronic devices 200, 400 and 600 respectively.

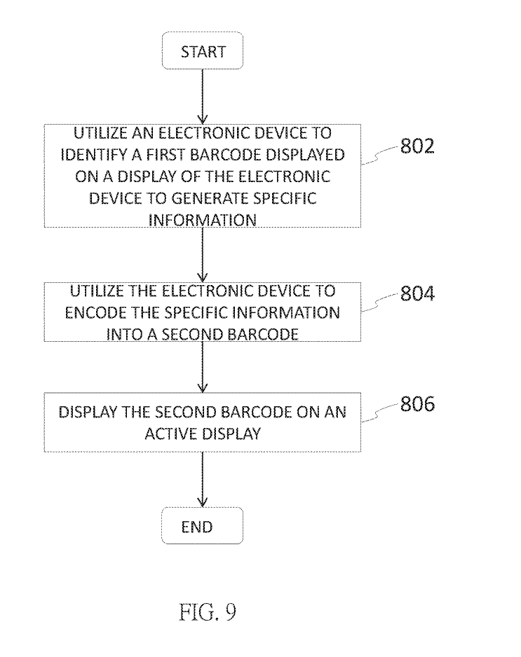

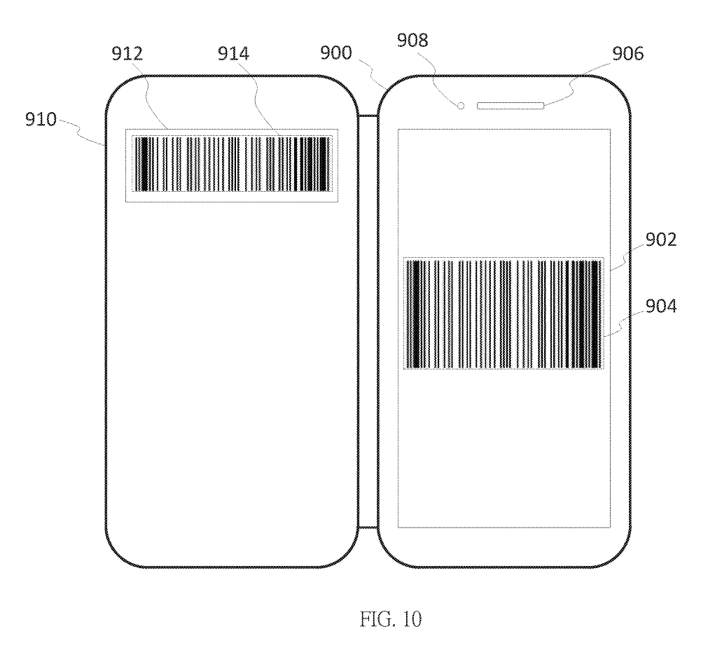

FIG. 9 is a flowchart illustrating a method for displaying a barcode according to still another embodiment of the present disclosure. Please refer to FIG. 9 in conjunction with FIG. 10. FIG. 10 is a diagram illustrating an electronic device employing the method of FIG. 9. An electronic device 900 includes a display 902, an ear speaker 906, a proximity sensor 908 and an external accessory 910. An active barcode display may be disposed in the ear speaker 906, the proximity sensor 908, or may be implemented on the external accessory 910 as an active barcode display 912. Implementation of the active barcode display is similar to the active barcode displays 302, 502 or 604. As a result, details of the active barcode display are omitted here for brevity. However, the present disclosure is not limited thereto. One of ordinary skill in the art would recognize many variations, modifications, and alternatives.

Referring to FIG. 10, the electronic device 900 is capable of identify or decode a first barcode 904 shown on the display 902 of the electronic device 900 in step 802. The electronic device 900 exerts the barcode identification every time when a barcode is shown on the display 902 either by directly decoding the barcode in step 802 or bringing the information package already embedded from the barcode provider to the next step 804. In some embodiments, the electronic device 900 exerts the barcode identification only when a request is made by a user. The electronic device 900 generates information according to the identified barcode. Then the electronic device 900 encodes the information into a second barcode in step 804 and displays the second barcode on an active barcode display in step 806, such as showing a second barcode 914 on the active barcode display 912. The steps 804-806 are the same or similar to the steps 704-706 of FIG. 8; thus, details are omitted here for brevity. The method shown in FIG. 9 can be applied to the electronic devices 200, 400 and 600 respectively. One of ordinary skill in the art would recognize many variations, modifications, and alternatives.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for displaying a barcode, the method comprising:
utilizing an electronic device to obtain information; and
displaying a barcode on an active barcode display of the electronic device according to the information;
wherein when displaying the barcode on the active barcode display, a contrast ratio of black and white bar codes in the barcode is greater than about 30%.

2. The method of claim 1, wherein the information is the barcode, and the displaying of the barcode on the active barcode display according to the information comprises:
displaying the barcode obtained by the electronic device on the active barcode display of the electronic device.

3. The method of claim 1, wherein the displaying of the barcode on the active barcode display according to the information comprises:
utilizing the electronic device to encode the information into a barcode; and
displaying the barcode on the active barcode display of the electronic device.

4. The method of claim 1, wherein the utilizing of the electronic device to obtain the information comprises utilizing the electronic device to obtain the information via wireless/wired transmission.

5. The method of claim 1, further comprising:
utilizing the electronic device to transmit the barcode to be displayed to the active barcode display via wireless transmission.

6. The method of claim 1, further comprising:
displaying a guide message instructing a barcode reader to approach the active barcode display on a display of the electronic device.

7. The method of claim 1, wherein the barcode is a one-dimensional barcode or a two-dimensional barcode.

8. An electronic device, comprising:
a receiving unit, arranged for obtaining information; and
an active barcode display, arranged for displaying a barcode according to the information;
wherein when displaying the barcode, a contrast ratio of black and white bar codes in the barcode on the active barcode display is greater than about 30%.

9. The electronic device of claim 8, wherein the active barcode display is selected from the group of an electroluminescent display, a liquid crystal display (LCD) with backlighting, a cathodoluminescent display, a photoluminescent display, and an incandescent display.

10. The electronic device of claim 8, wherein the active barcode display is an organic light-emitting diode (OLED) display comprising light absorbing materials in the cathode and/or pixel gap area.

11. The electronic device of claim 8, wherein the active barcode display is a light emitting diode (LED) display comprising light absorbing materials.

12. The electronic device of claim 8, wherein the electronic device further includes a display, and the active barcode display and the display are located at a same side of the electronic device.

13. The electronic device of claim 8, wherein the active barcode display is integrated with a proximity sensor or an ear speaker of the electronic device.

14. The electronic device of claim 8, wherein the active barcode display is located at an external accessory of the electronic device.

15. A method for displaying a barcode, the method comprising:
utilizing an electronic device to identify a first barcode displayed on a display of the electronic device to generate information; and
displaying a second barcode on an active barcode display of the electronic device according to the information;
wherein when displaying the second barcode on the active barcode display of the electronic device, a contrast ratio of black and white bar codes in the second barcode is greater than about 30%.

16. The method of claim 15, wherein the displaying of the second barcode on the active barcode display according to the information comprises:
utilizing the electronic device to encode the information into the second barcode; and
displaying the second barcode on the active barcode display of the electronic device.

17. The method of claim 15, further comprising:
utilizing the electronic device to transmit the second barcode to be displayed to the active barcode display via wireless transmission.

18. The method of claim 15, wherein the barcode is a one-dimensional barcode or a two-dimensional barcode.

19. An electronic device, comprising:
a receiving unit, arranged for identifying a barcode displayed on a display of the electronic device to generate information;
an active barcode display, arranged for displaying a second barcode according to the information;
wherein when displaying the second barcode, a contrast ratio of black and white bar codes in the second barcode on the active barcode display is greater than about 30%.

20. The electronic device of claim 19, wherein the active barcode display is selected from the group of an electroluminescent display, a liquid crystal display (LCD) with backlighting, a cathodoluminescent display, a photoluminescent display, and an incandescent display.

21. The electronic device of claim 19, wherein the active barcode display is an organic light-emitting diode (LED) display comprising light absorbing materials in the cathode and/or pixel gap area.

22. The electronic device of claim 19, wherein the active barcode display is a light emitting diode (LED) display comprising light absorbing materials.

23. The electronic device of claim 19, wherein the electronic device further includes a display, and the active barcode display and the display are located at a same side of the electronic device.

24. The electronic device of claim 19, wherein the active barcode display is integrated with a proximity sensor or an ear speaker of the electronic device.

25. The electronic device of claim 19, wherein the active barcode display is located at an external accessory of the electronic device.
